(19) United States
(12) Patent Application Publication
(10) Pub. No.: US 2008/0173353 A1
(43) Pub. Date: Jul. 24, 2008

(54) GAS SUPPLY PIPING SYSTEM AND METHOD FOR REPLACING PURIFIER

(75) Inventors: Chieh-Hsing Chen, Kaohsiung City (TW); Tsung-Yang Chen, Tainan City (TW); Chin-Wang Chiu, Tainan County (TW); Shih-Hsun Chang, Taichung County (TW)

Correspondence Address: J C PATENTS, INC., 4 VENTURE, SUITE 250, IRVINE, CA, 92618, US

(73) Assignee: United Microelectronics Corp., Hsinchu (TW)

(21) Appl. No.: 11/625,447

(22) Filed: Jan. 22, 2007

(51) Int. Cl. B08B 9/02

(52) U.S. Cl. 137/15.08; 137/614

(57) ABSTRACT

A gas supply piping system suitable for transporting a gas to a machine terminal from a gas supply terminal is provided, which includes a main supply pipe, a plurality of branch supply pipes, a plurality of purifiers, a plurality of first valves and a backup piping. The main supply pipe is connected to the gas supply terminal. The branch supply pipes are connected the main supply pipe and the machine terminal respectively. The purifiers are connected to the branch supply pipes respectively. The first valves are connected to the branch supply pipes respectively and located between the purifiers and the gas supply terminal. The backup piping is connected to the branch supply pipes and disposed between the purifiers and the machine terminal.

### BACKGROUND OF THE INVENTION

1. Field of the Invention

The present invention relates to a gas supply piping system and a method for replacing a purifier thereof, and more particularly to a gas supply piping system and a method for replacing a purifier thereof such that the machine need not be shut down when replacing the purifier.

2. Description of Related Art

In the semiconductor-manufacturing process, many gas-phase processes are used for manufacturing devices. As for the high purity bulk gas used in the gas-phase process, the gas is supplied to the semiconductor machine through a gas supply piping system. However, the high purity bulk gas also has small amount of impurities, which negatively influences the performance of the device.

Currently, the impurities in the gas are removed by directly mounting the purifier in the supply pipe to filter the impurities from the gas flowing there-through. However, according to the design of the conventional gas supply piping system, for replacing the purifier, the whole gas supply system must be stopped, and the semiconductor machine must be shut down.

In addition, after a new purifier has been mounted, an action of activating the process environment lasting for 4-8 hours is required before the gas can be re-supplied into the semiconductor machine. Thus, during the above period of time, the semiconductor machine cannot be operated normally.

### SUMMARY OF THE INVENTION

An objective of the present invention is to provide a gas supply piping system, wherein when replacing the purifier, the semiconductor machine need not be shut down.

Another objective of the present invention is to provide a gas supply piping system, wherein after a new purifier has been mounted, the semiconductor machine works normally during the activating the process environment.

Still another objective of the present invention is to provide a method for replacing a purifier while the whole gas supply system is working normally.

The present invention provides a gas supply piping system suitable for transporting gas from a gas supply terminal to a machine terminal, which comprises a main supply pipe, a plurality of branch supply pipes, a plurality of purifiers, a plurality of first valves and a backup piping. The main supply pipe is connected to the gas supply terminal. The branch supply pipes are connected to the main supply pipe and the machine terminal respectively. The purifiers are connected to each of the branch supply pipes respectively. The first valves are connected to each of the branch supply pipes respectively, and are located between the purifier and the gas supply terminal. The backup piping is connected to the branch supply pipes and disposed between the purifier and the machine terminal.

According to an embodiment of the present invention, in the above gas supply piping system, the backup piping comprise at least one backup pipe, at least one second valve and a plurality of third valves. The backup pipe is connected to two adjacent branch supply pipes. The second valve is connected to the corresponding backup pipe. The third valves are connected to each of the branch supply pipes respectively, and are located between the purifiers and the backup pipe.

According to an embodiment of the present invention, the above gas supply piping system further comprises a plurality of four valves connected to each of the branch supply pipes respectively and located between the backup piping and the machine terminal.

According to an embodiment of the present invention, the above gas supply piping system further comprises a plurality of exhausting valves respectively connected to each corresponding branch supply pipe, and between the backup piping and the purifiers.

According to an embodiment of the present invention, the above gas supply piping system further comprises a vacuum generator connected to the exhausting valves.

According to an embodiment of the present invention, the gas comprises a dangerous gas.

According to an embodiment of the present invention, the dangerous gas comprises SiH₄, GeH₄ or HCl.

The present invention provides another gas supply piping system suitable for transporting the gas from a gas supply terminal to a machine terminal, which comprises a main supply pipe, a first branch supply pipe and a second branch supply pipe, a first purifier, a second purifier, a first valve, a second valve, a first backup pipe, a third valve, a fourth valve and a fifth valve. The main supply pipe is connected to the gas supply terminal. The first and second branch supply pipes are respectively connected to the main supply pipe and the machine terminal. The first and second purifiers are respectively connected to the first and second branch supply pipes. The first and second valves are respectively connected to the first and second branch supply pipes, wherein the first valve is located between the first purifier and the gas supply terminal, and the second valve is located between the second purifier and the gas supply terminal. The first backup pipe is connected to the first and second branch supply pipes. The third valve is connected to the first backup pipe. The fourth and fifth valves are respectively connected to the first and second branch supply pipes, wherein the fourth valve is located between the first purifier and the first backup pipe, and the fifth valve is located between the second purifier and the first backup pipe.

According to an embodiment of the present invention, the above gas supply piping system further comprises a third branch supply pipe, a third purifier, a sixth valve, a second backup pipe, a seventh valve and an eighth valve. The third branch supply pipe is connected to the main supply pipe and the machine terminal. The third purifier is connected to the third branch supply pipe. The sixth valve is connected to the third branch supply pipe, and is located between the third purifier and the gas supply terminal. The second backup pipe is used to connect the second branch supply pipe with the third branch supply pipe. The seventh valve is connected to the second backup pipe. The eighth valve is connected to the third branch supply pipe, and is located between the third purifier and the second backup pipe.

According to an embodiment of the present invention, the above gas supply piping system further comprises a ninth valve connected to the third branch supply pipe, and is located between the second backup pipe and the machine terminal.

According to an embodiment of the present invention, the above gas supply piping system further comprises a third exhausting valve connected to the third branch supply pipe, and is located between the eighth valve and the third purifier.

According to an embodiment of the present invention, the above gas supply piping system further comprises a vacuum generator connected to the third exhausting valve.

According to an embodiment of the present invention, the above gas supply piping system further comprises a tenth valve and an eleventh valve respectively connected to the first and second branch supply pipes, and are located between the first backup pipe and the machine terminal.

According to an embodiment of the present invention, the above gas supply piping system further comprises a first exhausting valve and a second exhausting valve respectively connected to the first and second branch supply pipes, wherein the first exhausting valve is connected between the fourth valve and the first purifier, and the second exhausting valve is connected between the fifth valve and the second purifier.

According to an embodiment of the present invention, the above gas supply piping system further comprises a vacuum generator connected to the first and second exhausting valves.

According to an embodiment of the present invention, the gas includes a dangerous gas.

According to an embodiment of the present invention, the dangerous gas includes SiH₄, GeH₄ or HCl.

The present invention provides a method for replacing a purifier, suitable for the above gas supply piping system, wherein the gas is transported to the machine terminal via the first and second branch supply pipes, and at this time, the third valve is turned off. The method for replacing a purifier comprises turning off the fifth valve first, turning on the third valve, turning off the second valve, and replacing the second purifier.

According to an embodiment of the present invention, further comprising a step of drawing the gas from the second branch supply pipe between the fifth valve and the second valve with a vacuum generator after turning off the fifth valve and the second valve.

According to an embodiment of the present invention, the dangerous gas includes SiH₄, GeH₄ or HCl.

In view of the above, since the gas supply piping system of the present invention has a backup piping, when replacing the purifier, via controlling the backup pipe and the valve in the backup piping, the gas supplied by other branch supply pipes is transported to the branch supply pipe having the replaced purifier to backup, and then, the gas is transported to the semiconductor machine corresponding to the branch supply pipe having the replaced purifier. Therefore, the semiconductor machine need not be shut down when replacing the purifier. Furthermore, after mounting a new purifier, the semiconductor machine may operate normally when activating the process environment.

Furthermore, in the method for replacing the purifier provided by the present invention, by bypassing the gas flow through the backup piping, the purifier may be replaced without stopping the whole gas supply system and shutting down the semiconductor machine.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a gas supply piping system according to an embodiment of the present invention.

FIG. 2 is a schematic view of a gas supply piping system according to another embodiment of the present invention.

### DESCRIPTION OF EMBODIMENTS

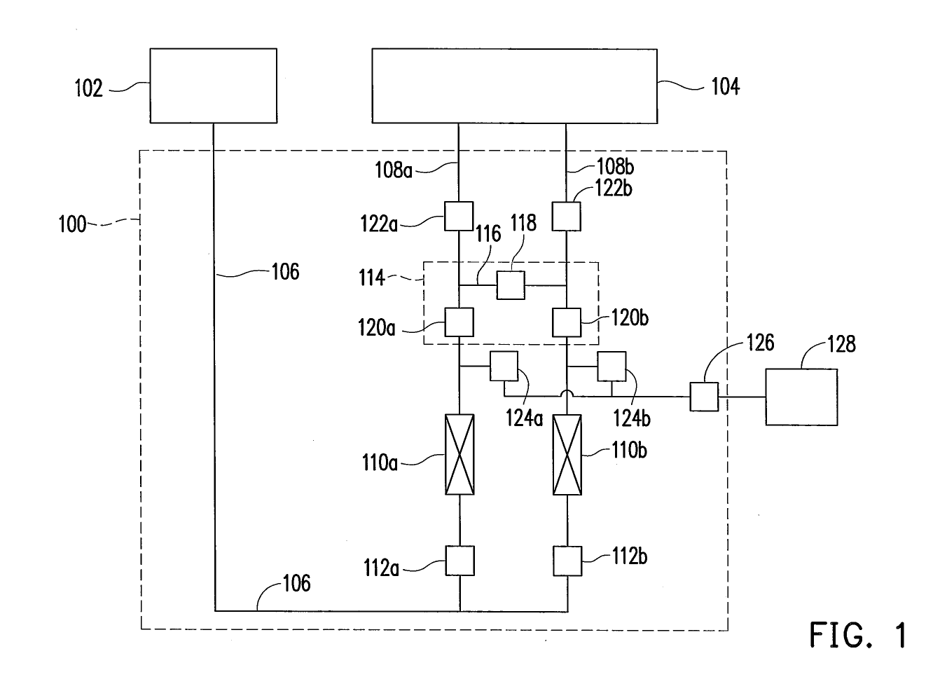

FIG. 1 is a schematic view of a gas supply piping system according to an embodiment of the present invention.

Referring to FIG. 1, the gas supply piping system 100 provided in the present invention is suitable for transporting a gas from a gas supply terminal 102 to a machine terminal 104. The gas supplied by the gas supply terminal 102 is, for example, a dangerous gas, such as SiH₄, GeH₄ and HCl. The machine terminal 104 includes a plurality of semiconductor machines, for example, etching machines and depositing machines.

The gas supply piping system 100 includes a main supply pipe 106, branch supply pipes 108a and 108b, purifiers 110a and 110b, valves 112a and 112b, and a backup piping 114.

The main supply pipe 106 is connected to the gas supply terminal 102 and the branch supply pipes 108a and 108b. The branch supply pipes 108a and 108b are connected to the main supply pipe 106 and the machine terminal 104 respectively. Therefore, the gas from the gas supply terminal 102 is distributed to the branch supply pipes 108a and 108b via the main supply pipe 106, and then transported to the semiconductor machine corresponding to the machine terminal 104 via the branch supply pipes 108a and 108b.

The purifiers 110a and 110b are connected to the branch supply pipes 108a and 108b respectively, for filtering the impurities contained in the gas flowing through the branch supply pipes 108a and 108b respectively.

The valves 112a and 112b are connected to the branch supply pipes 108a and 108b respectively, wherein the valve 112a is located between the purifier 110a and the gas supply terminal 102, and the valve 112b is located between the purifier 110b and the gas supply terminal 102, and are used to control the gas flow through the branch supply pipes 108a and 108b.

The backup piping 114 is connected to the branch supply pipes 108a and 108b and disposed between the purifiers 110a and 110b and the machine terminal 104. The backup piping 114 includes a backup pipe 116, a valve 118 and valves 120a and 120b. The backup pipe 116 is used to connect the two adjacent branch supply pipes 108a and 108b. The valve 118 is connected to the backup pipe 116. The valves 120a and 120b are connected to the branch supply pipes 108a and 108b respectively, wherein the valve 120a is located between the purifier 110a and the backup pipe 116, and the valve 120b is located between the purifier 110b and the backup pipe 116.

The gas supply piping system 100 includes valves 122a and 122b, which are connected to the branch supply pipes 108a and 108b respectively, located between the backup piping 114 and the machine terminal 104, and are used to control the supply volume of the gas transported to the machine terminal 104 via the branch supply pipes 108a and 108b.

The gas supply piping system 100 further includes exhausting valves 124a and 124b and a vacuum generator 126. The exhausting valves 124a and 124b are connected to the corresponding branch supply pipes 108a and 108b respectively, and disposed between the backup piping 114 and the purifiers 110a and 110b. The vacuum generator 126, connected to the exhausting valves 124a and 124b, is used to draw the gas from the branch supply pipes 108a and 108b to a gas exhaust terminal 128.

The method for replacing the purifier 110b is illustrated below.

During the normal operation of the semiconductor machine, the gas from the gas supply terminal 102 is distributed to the branch supply pipes 108a and 108b via the main supply pipe 106 in the gas supply piping system 100, and then transported to the semiconductor machine corresponding to the machine terminal 104 via the branch supply pipes 108a and 108b, and at this point, the valve 118 is turned off.

In the method for replacing the purifier 110b, the valve 120b is turned off first.

Next, the valve 118 is turned on so that the gas from the branch supply pipe 108a may be transported to the branch supply pipe 108b via the backup pipe 116. Because the valve 120b has been turned off in advance, the gas transported from the branch supply pipe 108a could be avoided entering into the branch supply pipe 108b between the valve 120b and the valve 112b.

Next; the valve 112b is turned off so that the gas from the main supply pipe 106 is stopped from entering into the supply pipe 108a to avoid the leakage of the gas caused by the continuous supplying of the gas while replacing the purifier 112b. Finally, the purifier 110b is replaced.

In addition, after the valve 120b and the valve 112b have been turned off, the residual gas in the branch supply pipe 108b between the valve 120b and the valve 112b may be drawn out by the vacuum generator 126, and thereby preventing the leakage of the residual gas while replacing the purifier 110b.

Since the gas supply piping system 100 in the present invention has a backup piping 114, when replacing the purifier 110b, through the backup pipe 116 in the backup piping 114 and by controlling the valves 118 and 120b, the gas supplied from the branch supply pipe 108a is transported to the branch supply pipe 108b of the replaced purifier 110b to backup, and then, the gas is transported to the semiconductor machine corresponding to the branch supply pipe 108b, therefore, the purifier 110b may be replaced without shutting down the semiconductor machine and stopping the whole gas supply system.

Furthermore, since the gas from the branch supply pipe 108a can be transported to the branch supply pipe 108b of the replaced purifier 110b to backup, after the new purifier 110b has been mounted, the semiconductor machines may still operate normally when activating the process environment.

It should be noted that, although only the method for replacing the purifier 110b connected to the branch supply pipe 108b has been described in the above embodiment, the method for replacing the purifier 110a connected to the branch supply pipe 108a may be easily deduced by those skilled in the art, which thus will not be described herein.

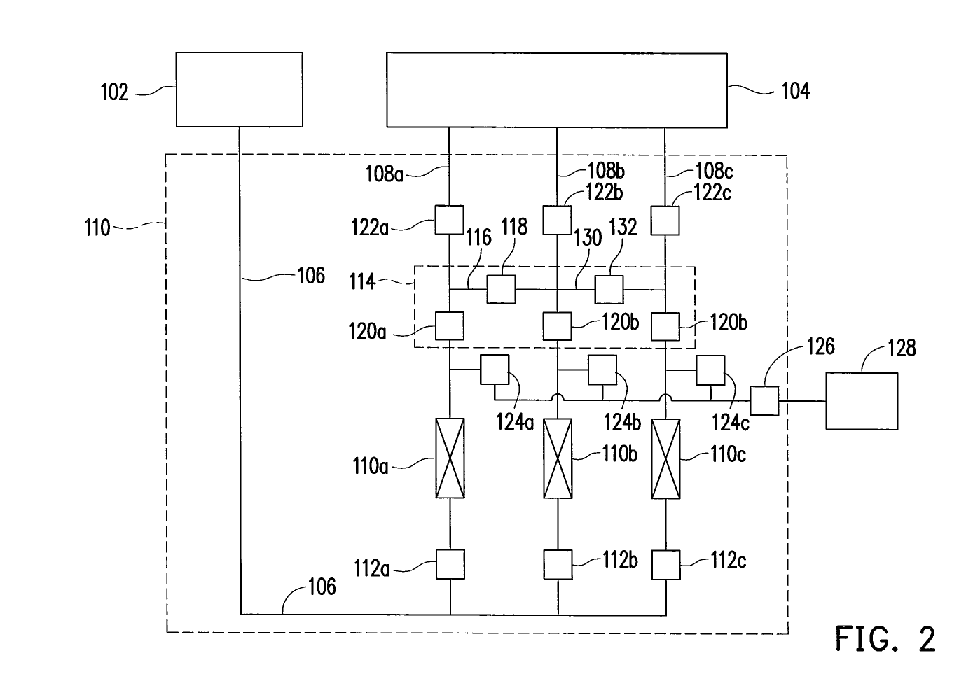

FIG. 2 is a schematic view of a gas supply piping system according to another embodiment of the present invention.

Referring to both FIGS. 1 and 2, the only difference between FIG. 2 and FIG. 1 lies in that, compared to the gas supply piping system 100 in FIG. 1, the gas supply piping system 110 in FIG. 2 further includes an additional branch supply pipe 108c, a purifier 110c, a valve 112c, a valve 120c, a valve 122c, a valve 132, a backup pipe 130 and a exhausting valve 124c, and other devices in FIG. 2 are the same as those in FIG. 1, which thus will not be repeated herein.

The branch supply pipe 108c is used to connect the main supply pipe 106 to the machine terminal 104. Thus, the gas in the gas supply terminal 102 is distributed to the branch supply pipe 108c via the main supply pipe 106, and then transported to the semiconductor machine corresponding to the machine terminal 104 via the branch supply pipe 108c.

The purifier 110c is connected the branch supply pipe 108c for filtering the impurities contained in the gas flowing through the branch supply pipe 108c.

The valve 112c is connected the branch supply pipe 108c and is located between the purifier 110c and the gas supply terminal 102, and is used to control the supply of the gas in the branch supply pipe 108c.

The backup piping 114 in FIG. 2 further includes a backup pipe 130, a valve 132 and a valve 120c. The backup pipe 130 is used to connect two adjacent branch supply pipes 108b and 108c. The valve 132 is connected to the corresponding backup pipe 130. The valve 120c is connected the branch supply pipe 108c and is located between the purifier 110c and the backup pipe 130.

The valve 122c is connected to the branch supply pipe 108c and is located between the backup piping 130 and the machine terminal 104, and used to control the supply volume of the gas transported to the machine terminal 104 via the branch supply pipe 108c.

The exhausting valve 124c is connected to the corresponding branch supply pipe 108c, and is located between the backup piping 130 and the purifier 110c. The vacuum generator 126, connected to the exhausting valve 124c, is used to draw the gas from the branch supply pipe 108c to the gas exhaust terminal 128.

The method for replacing the purifier 110b is illustrated below.

Under the normal operation of the semiconductor machine, the gas from the gas supply terminal 102 is distributed to the branch supply pipes 108a, 108b and 108c via the main supply pipe 106 in the gas supply piping system 100, and then transported to the semiconductor machine corresponding to the machine terminal 104 via the branch supply pipes 108a, 108b and 108c, and at this point, the valves 118 and 132 are turned off.

In the method for replacing the purifier 110b, the valve 120b is turned off first, so as to prevent the gas subsequently transported from the branch supply pipes 108a and 108c from entering into the branch supply pipe 108b between the valve 120b and the valve 112b.

Next, the valve 118 is turned on so that the gas in the branch supply pipe 108a is transported to the branch supply pipe 108b via the backup pipe 116. Alternatively, the valve 132 is turned on so that the gas in the branch supply pipe 108c is transported to the branch supply pipe 108b via the backup pipe 130. Or alternatively, the valves 118 and 132 are both turned on so that the gas in the branch supply pipes 108a and 108c are transported to the branch supply pipe 108b via the backup pipes 116 and 130 respectively.

Next, the valve 112b is turned off so that the gas from the main supply pipe 106 cannot enter into the supply pipe 108a, so the purifier 110b may be replaced without the risk of gas leakage. Finally, the purifier 110b is replaced.

In addition, after the valve 120b and the valve 112b have been turned off, the residual gas in the branch supply pipe 108b between the valve 120b and the valve 112b may drawn out by the vacuum generator 126, and thereby preventing the leakage of the residual gas in the branch supply pipe 108b between the valve 120b and the valve 112b while replacing the purifier 110b.

Since the gas supply piping system 110 in the present invention has a backup piping 114, when replacing the purifier 110b, through the backup pipes 116 and 130 in the backup piping 114 and by controlling the valves 118, 120b, 132 and 120c, the gas supplied from the branch supply pipes 108a and 180c is transported to the branch supply pipe 108b of the replaced purifier 110b to backup, and then, the gas is transported to the semiconductor machine corresponding to the branch supply pipe 108b, therefore the purifier 110b may be replaced without shutting down the semiconductor machine and without stopping the whole gas supply system.

Furthermore, since the gas from the branch supply pipes 108a and 108c can be transported to the branch supply pipe 108b of the replaced purifier 110b to backup, after a new purifier 110b has been mounted, the semiconductor machines may still operate normally while activating the process environment.

It should be noted that, although only the method for replacing the purifier 110b connected to the branch supply pipe 108b has been described in the above embodiment, the method for replacing the purifiers 110a and 110c may be easily deduced by those skilled in the art, and therefore will not be described herein.

In addition, the gas supply piping system with two branch supply pipes and three branch supply pipes are respectively described in the embodiments of FIG. 1 and FIG. 2, as well as the method for replacing the purifier, however, those skilled in the art would be able to deduce the gas supply piping system with more than three branch supply pipes with reference to the embodiments of FIGS. 1 and 2, as well as the method for replacing the purifier, which thus will not be described herein any more.

To sum up, the present invention at least has the following advantages.

1. Since the gas supply piping system of the present invention has a backup piping, the purifier may be replaced without shutting down the semiconductor machine.

2. In the gas supply piping system of the present invention, the gas supplied from the branch supply pipe having purifier not being replaced may be transported to the branch supply pipe having the replaced purifier to backup, thus after a new purifier has been mounted, the semiconductor machine may be still operated normally while activating the process environment.

3. In the method for replacing the purifier of the present invention, the purifier is replaced through operating the backup piping, without stopping the whole gas supply system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following-claims and their equivalents.

What is claimed is:

1. A gas supply piping system, suitable for transporting a gas from a gas supply terminal to a machine terminal, comprising:
a main supply pipe, connected to the gas supply terminal;
a plurality of branch supply pipes, connected to the main supply pipe and the machine terminal respectively;
a plurality of purifiers, connected to each of the branch supply pipes respectively;
a plurality of first valves, connected to each of the branch supply pipes respectively, and located between the purifiers and the gas supply terminal; and
a backup piping, connected to the branch supply pipes and disposed between the purifiers and the machine terminal.

2. The gas supply piping system as claimed in claim 1, wherein the backup piping comprises:
at least one backup pipe, connected to two adjacent branch supply pipes;
at least one second valve, connected to the corresponding backup pipe; and
a plurality of third valves, connected to each of the branch supply pipes respectively, and located between the purifiers and the backup pipe.

3. The gas supply piping system as claimed in claim 1, further comprising a plurality of fourth valves connected to each of the branch supply pipes respectively and located between the backup piping and the machine terminal.

4. The gas supply piping system as claimed in claim 1, further comprising a plurality of exhausting valves respectively connected to each of the corresponding branch supply pipes, and located between the backup piping and the purifiers.

5. The gas supply piping system as claimed in claim 1, further comprising a vacuum generator connected to the exhausting valves.

6. The gas supply piping system as claimed in claim 1, wherein the gas includes a dangerous gas.

7. The gas supply piping system as claimed in claim 1, wherein the dangerous gas includes SiH₄, GeH₄ or HCl.

8. A gas supply piping system, suitable for transporting a gas from a gas supply terminal to a machine terminal, comprising:
a main supply pipe, connected to the gas supply terminal;
a first branch supply pipe and a second branch supply pipe, connected to the main supply pipe and the machine terminal respectively;
a first purifier and a second purifier, connected to the first and second branch supply pipes respectively;
a first valve and a second valve, connected to the first and second branch supply pipes respectively, wherein the first valve is located between the first purifier and the gas supply terminal, and the second valve is located between the second purifier and the gas supply terminal;
a first backup pipe, connecting the first branch supply pipe to the second branch supply pipe;
a third valve, connected to the first backup pipe; and
a fourth valve and a fifth valve, connected to the first and second branch supply pipes respectively, wherein the fourth valve is located between the first purifier and the first backup pipe, and the fifth valve is located between the second purifier and the first backup pipe.

9. The gas supply piping system as claimed in claim 8, further comprising:
a third branch supply pipe, connecting the main supply pipe to the machine terminal;
a third purifier, connected to the third branch supply pipe;
a sixth valve, connected to the third branch supply pipe, and located between the third purifier and the gas supply terminal;
a second backup pipe, connecting the second branch supply pipe to the third branch supply pipe;
a seventh valve, connected to the second backup pipe; and
an eighth valve, connected to the third branch supply pipe, and located between the third purifier and the second backup pipe.

10. The gas supply piping system as claimed in claim 9, further comprising a ninth valve, is connected to the third branch supply pipe, and located between the second backup pipe and the machine terminal.

11. The gas supply piping system as claimed in claim 9, further comprising a third exhausting valve connected to the third branch supply pipe, and located between the eighth valve and the third purifier.

12. The gas supply piping system as claimed in claim 11, further comprising a vacuum generator connected to the third exhausting valve.

13. The gas supply piping system as claimed in claim 8, further comprising a tenth valve and an eleventh valve connected to the first and second branch supply pipes respectively, and located between the first backup pipe and the machine terminal.

14. The gas supply piping system as claimed in claim 8, further comprising a first exhausting valve and a second exhausting valve connected to the first and second branch supply pipes respectively, wherein the first exhausting valve is connected between the fourth valve and the first purifier, and the second exhausting valve is connected between the fifth valve and the second purifier.

15. The gas supply piping system as claimed in claim 14, further comprising a vacuum generator connected to the first and second exhausting valves.

16. The gas supply piping system as claimed in claim 8, wherein the gas includes a dangerous gas.

17. The gas supply piping system as claimed in claim 8, wherein the dangerous gas includes SiH₄, GeH₄ or HCl.

18. A method for replacing a purifier, suitable for a gas supply piping system as claimed in claim 8, wherein the gas is transported to the machine terminal via the first and second branch supply pipes, and the third valve is turned off, the method comprising:
turning off the fifth valve;
turning on the third valve;
turning off the second valve; and
replacing the second purifier.

19. The method for replacing a purifier as claimed in claim 18, further comprising a step of drawing the gas from the second branch supply pipe between the fifth valve and the second valve with a vacuum generator after turning off the fifth valve and the second valve.

20. The method for replacing a purifier as claimed in claim 18, wherein the dangerous gas includes SiH₄, GeH₄ or HCl.
